(19) United States
(12) Patent Application Publication
(10) Pub. No.: US 2018/0270797 A1
(43) Pub. Date: Sep. 20, 2018

(54) METHOD OF TRANSMITTING AND RECEIVING DOWNLINK CHANNEL IN SHORT TTI FRAME STRUCTURE AND APPARATUS THEREOF

(71) Applicant: KT CORPORATION, Gyeonggi-do (KR)

(72) Inventors: Ki-tae KIM, Seoul (KR); Woo-jin CHOI, Seoul (KR)

(73) Assignee: KT CORPORATION, Gyeonggi-do (KR)

(21) Appl. No.: 15/915,247

(22) Filed: Mar. 8, 2018

(30) Foreign Application Priority Data
Mar. 14, 2017 (KR) 10-2017-0031982
Jan. 2, 2018 (KR) 10-2018-0000118

(51) Int. Cl. H04W 72/04

(52) U.S. Cl. CPC H04W 72/042; H04W 72/0446

(57) ABSTRACT

Provided are operation of a User Equipment (UE) and an evolved NodeB (eNB) for transmitting and receiving a downlink channel in a short transmission time interval frame structure of the 3GPP LTE/LTE-Advanced system, and a method of receiving a downlink channel in a short transmission time interval (sTTI) frame structure by a UE. The method may include receiving information associated with a shortened downlink control channel (sPDCCH) region from an eNB and receiving a downlink channel from the eNB based on the information associated with the sPDCCH region, wherein the sTTI is configured to include at least one of two symbols, three symbols, and seven symbols.

### CROSS REFERENCE TO RELATED APPLICATION

This application claims priority from Korean Patent Application Nos. 10-2017-0031982 & 10-2018-0000118, filed on Mar. 14, 2017 & Jan. 2, 2018, which are hereby incorporated by reference for all purposes as if fully set forth herein.

### BACKGROUND OF THE INVENTION

### 1. Field of the Invention

The present embodiments relate to operation of a User Equipment (UE) and an evolved NodeB (eNB) for transmitting and receiving a downlink channel in a short Transmission Time Interval (sTTI) frame structure of the 3^{rd} generation partnership project (GPP) long term evolution (LTE)/LTE-Advanced system.

### 2. Description of the Prior Art

Study and discussion have been in progress for reducing latency in the 3GPP LTE/LTE-Advanced system. The main purpose for such latency reduction is to standardize the operation of a short Transmission Time Interval (hereinafter referred to as “short TTI” or “sTTI”) in order to improve the throughput of TCP.

In the case of the sTTI frame structure, a frame is configured of 2,3, or 7 symbol units in the typical LTE/LTE-Advanced frame structure, that is, TTI=1 ms=14/12 OFDM symbols. By transmitting and receiving data based on an sTTI frame structure, latency may be reduced and data throughput may be improved.

To this end, discussions have been in progress for the performance of a short TTI. Furthermore, there are discussions in progress for the feasibility of a TTI length between 0.5 ms and a single OFDM symbol, the performance thereof, backward compatibility, and the like.

Although studies on the physical layer of a short TTI are being conducted, a detailed procedure has not yet been provided for transmission and reception of a downlink channel in a short TH. Specifically, a detailed procedure has not yet been provided for configuring a shortened PDCCH (sPDCCH) region, which is a downlink control channel in a short TTI, and respectively allocating time/frequency resources to an sPDCCH which is a downlink control channel in the short TTI and a shortened PDSCH (sPDCCH), which is a downlink data channel in the short TTI based on information associated with the configured sPDCCH region.

### SUMMARY OF THE INVENTION

An aspect of the present disclosure is to provide a detailed operation method of a User Equipment (UE) and an evolved NodeB (eNB), in association with configuring an sPDCCH region in a short TTI frame structure, allocating resources to an sPDCCH and an sPDSCH based on information associated with the sPDCCH region, and performing transmission and reception.

In accordance with an aspect of the present disclosure, there is provided a method of receiving a downlink channel in a short transmission time interval (sTTI) frame structure by a UE, the method including: receiving information associated with a shortened downlink control channel (shortened PDCCH (sPDCCH)) region from an eNB; and receiving a downlink channel from the eNB based on the information associated with the sPDCCH region, wherein the sTTI is configured to include at least one of two, three, and seven symbols.

In accordance with an aspect of the present disclosure, there is provided a method of transmitting a downlink channel in a short Transmission Time Interval (sTTI) frame structure by an eNB, the method including: configuring information associated with a shortened downlink control channel (shortened PDCCH (sPDCCH)) region; transmitting the information associated with the sPDCCH region to a UE; and transmitting a downlink channel to the UE based on the information associated with the sPDCCH region, wherein the sTTI is configured to include at least one of two, three, and seven symbols.

In accordance with an aspect of the present disclosure, there is provided a UE for receiving a downlink channel in a short Transmission Time Interval (sTTI) frame structure, the UE including: a receiver configured to receive information associated with a shortened downlink control channel (shortened PDCCH (sPDCCH)) region from an eNB, and to receive a downlink channel from the eNB based on the information associated with the sPDCCH region; and a controller configured to detect at least one of downlink control information and downlink data from the downlink channel, wherein the sTTI is configured to include at least one of two, three, and seven symbols.

In accordance with an aspect of the present disclosure, there is provided an eNB for transmitting a downlink channel in a short Transmission Time Interval (sTTI) frame structure, the eNB including: a controller configured to configure information associated with a shortened downlink control channel (shortened PDCCH (sPDCCH)) region; and a transmitter configured to transmit the information associated with the sPDCCH region to a UE, and to transmit a downlink channel to the UE based on the information associated with the sPDCCH region, wherein the sTTI is configured to include at least one of two, three, and seven symbols.

As described above, the present embodiments may provide a detailed operation method of a UE and an eNB, in association with configuring an sPDCCH region in a short TTI frame structure, allocating resources to an sPDCCH and an sPDSCH based on information associated with the sPDCCH region, and performing transmission and reception.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a diagram illustrating processing delays and a HARQ Round Trip Time (RTT) in an evolved NodeB (eNB) and a User Equipment (UE);

FIG. 2 is a diagram illustrating resource mapping per Physical Resource Block (PRB) in one subframe;

FIG. 3 is a diagram illustrating a uplink structure of a legacy PUCCH;

FIG. 4 is a conceptual diagram illustrating configuration of a legacy PUCCH;

FIG. 5 is a flowchart illustrating a procedure of receiving a downlink channel in a short Transmission Time Interval (sTTI) frame structure by a UE according to at least one of embodiments;

FIG. 6 is a flowchart illustrating a procedure of transmitting a downlink channel in an sTTI frame structure by an eNB according to at least one of embodiments;

FIG. 7 is a diagram illustrating an sTTI configured to include two or three symbols in a downlink;

FIG. 8 is a diagram illustrating an example of an sPDCCH region configuration based on a time domain in a 2-symbol sTTI according to at least one embodiment;

FIG. 9 is a diagram illustrating an example of an sPDCCH region configuration based on a frequency domain in a 2-symbol sTTI according to at least one embodiment;

FIG. 10 is a diagram illustrating an example of a single symbol-based sCCE configuration in a 2-symbol sTTI according to at least one embodiment;

FIG. 11 is a diagram illustrating an example of a 2-symbol-based sCCE configuration in a 2-symbol sTTI according to at least one embodiment;

FIG. 12 is a diagram illustrating a method of allocating an sCCE that is not used in an sPDCCH region to an sPDSCH according to at least one embodiment;

FIG. 13 is a diagram illustrating a configuration of an eNB according to at least one of embodiments; and

FIG. 14 is a diagram illustrating a configuration of a UE according to at least one of embodiments.

### DETAILED DESCRIPTION OF THE EXEMPLARY EMBODIMENTS

Hereinafter, embodiments of the present disclosure will be described in detail with reference to the accompanying drawings. In adding reference numerals to elements in each drawing, the same elements will be designated by the same reference numerals, if possible, although they are shown in different drawings. Further, in the following description of the present disclosure, a detailed description of known functions and configurations incorporated herein will be omitted when it is determined that the description may make the subject matter of the present disclosure rather unclear.

In the present specifications, a machine type communication (MTC) terminal refers to a terminal that is low cost (or is not very complexity), a terminal that supports coverage enhancement, or the like. In the present specifications, the MTC terminal refers to a terminal that supports low cost (or low complexity) and coverage enhancement. Alternatively, in the present specifications, the MTC terminal refers to a terminal that is defined as a predetermined category for maintaining low costs (or low complexity) and/or coverage enhancement.

In other words, in the present specifications, the MTC terminal may refer to a newly defined 3GPP Release 13 low cost (or low complexity) UE category/type, which executes LTE-based MTC related operations. Alternatively, in the present specifications, the MTC terminal may refer to a UE category/type that is defined in or before 3GPP Release-12 that supports the enhanced coverage in comparison with the existing LTE coverage, or supports low power consumption, or may refer to a newly defined Release 13 low cost (or low complexity) UE category/type.

The wireless communication system may be widely installed to provide various communication services, such as a voice service, packet data service, and the like. The wireless communication system may include a User Equipment (UE) and a Base Station (BS or an eNB). Throughout the specifications, the user equipment may be an inclusive concept indicating a user terminal utilized in wireless communication, including a UE (User Equipment) in wideband code division multiple access (WCDMA), LTE, high speed packet access (HSPA), and the like, and an MS (Mobile station), a UT (User Terminal), an SS (Subscriber Station), a wireless device, and the like in global systems for mobile communication (GSM).

A base station or a cell may generally refer to a station where communication with a User Equipment (UE) is performed, and such a base station or cell may also be referred to as a Node-B, an evolved Node-B (eNB), a Sector, a Site, a Base Transceiver System (BTS), an Access Point, a Relay Node, a Remote Radio Head (RRH), a Radio Unit (RU), and the like.

That is, the base station or the cell may be construed as an inclusive concept indicating a portion of an area covered by a BSC (Base Station Controller) in CDMA, a NodeB in WCDMA, an eNB or a sector (site) in LTE, and the like, and the concept may include various coverage areas, such as a megacell, a macrocell, a microcell, a picocell, a femtocell, a communication range of a relay node, and the like.

Each of the above mentioned various cells has a base station that controls a corresponding cell, and thus, the base station may be construed in two ways. i) the base station may be a device itself that provides a megacell, a macrocell, a microcell, a picocell, a femtocell, and a small cell in association with a wireless area, or ii) the base station may indicate a wireless area itself. In i), all devices that interact with one another so as to enable the devices that provide a predetermined wireless area to be controlled by an identical entity or to cooperatively configure the wireless area, may be indicated as a base station. Based on a configuration type of a wireless area, an eNB, an RRH, an antenna, an RU, a Low Power Node (LPN), a point, a transmission/reception point, a transmission point, a reception point, and the like may be embodiments of a base station. In ii), a wireless area itself that receives or transmits a signal from a perspective of a terminal or a neighboring base station, may be indicated as a base station.

Therefore, a megacell, a macrocell, a microcell, a picocell, a femtocell, a small cell, an RRH, an antenna, an RU, an LPN, a point, an eNB, a transmission/reception point, a transmission point, and a reception point are commonly referred to as a base station.

In the specifications, the user equipment and the base station are used as two inclusive transceiving subjects to embody the technology and technical concepts described in the specifications, and the user equipment and the base station may not be limited to a predetermined term or word. In the specification, the user equipment and the base station are used as two (uplink or downlink) inclusive transceiving subjects to embody the technology and technical concepts described in the specifications, and the user equipment and the base station may not be limited to a predetermined term or word. Here, Uplink (UL) refers to a scheme for a UE to transmit and receive data to/from a base station, and Downlink (DL) refers to a scheme for a base station to transmit and receive data to/from a UE.

Varied multiple access schemes may be unrestrictedly applied to the wireless communication system. Various multiple access schemes, such as CDMA (Code Division Multiple Access), TDMA (Time Division Multiple Access), FDMA (Frequency Division Multiple Access), OFDMA (Orthogonal Frequency Division Multiple Access), OFDM-FDMA, OFDM-TDMA, OFDM-CDMA, and the like may be used. An embodiment of the present disclosure may be applicable to resource allocation in an asynchronous wireless communication scheme that is advanced through GSM, WCDMA, and HSPA, to be LTE and LTE-advanced, and may be applicable to resource allocation in a synchronous wireless communication scheme that is advanced through CDMA and CDMA-2000, to be UMB. The present disclosure may not be limited to a specific wireless communication field, and may include all technical fields in which the technical idea of the present disclosure is applicable.

Uplink transmission and downlink transmission may be performed based on a TDD (Time Division Duplex) scheme or an FDD (Frequency Division Duplex). The TDD scheme performs transmission based on different times. The FDD scheme performs transmission based on different frequencies.

Further, in a system such as LTE and LTE-A, a standard may be developed by configuring an uplink and a downlink based on a single carrier or a pair of carriers. The uplink and the downlink may transmit control information through a control channel, such as a PDCCH (Physical Downlink Control CHannel), a PCFICH (Physical Control Format Indicator CHannel), a PITCH (Physical Hybrid ARQ Indicator CHannel), a PUCCH (Physical Uplink Control CHannel), an EPDCCH (Enhanced Physical Downlink Control CHannel), and the like, and may be configured as a data channel, such as a PDSCH (Physical Downlink Shared CHannel), a PUSCH (Physical Uplink Shared CHannel), and the like, so as to transmit data.

Control information may be transmitted using an EPDCCH (enhanced PDCCH or extended PDCCH).

In the present specification, a cell may refer to the coverage of a signal transmitted from a transmission/reception point, a component carrier having the coverage of the signal transmitted from the transmission/reception point (transmission point or transmission/reception point), or the transmission/reception point itself.

A wireless communication system, according to embodiments, refers to i) a Coordinated Multi-point transmission/reception (CoMP) system where two or more transmission/reception points cooperatively transmit a signal, ii) a coordinated multi-antenna transmission system, or iii) a coordinated multi-cell communication system. A CoMP system may include at least two multi-transmission/reception points and terminals.

A multi-transmission/reception point may be a base station or at least one RRH that is connected to the eNB through an optical cable or an optical fiber, is wiredly controlled, and has a high transmission power or a low transmission power within a macro cell area.

Hereinafter, a downlink refers to communication or a communication path from a multi-transmission/reception point to a terminal, and an uplink refers to communication or a communication path from a terminal to a multi-transmission/reception point. In an uplink, a transmitter may be a part of a terminal and a receiver may be a part of a multiple transmission/reception point. In an uplink, a transmitter may be a part of a terminal and a receiver may be a part of a multiple transmission/reception point.

Hereinafter, the situation in which a signal is transmitted and received through a PUCCH, a PUSCH, a PDCCH, an EPDCCH, a PDSCH, or the like may be described through the expression, “a PUCCH, a PUSCH, a PDCCH, an EPDCCH, or a PDSCH is transmitted or received”.

In addition, hereinafter, the expression “a PDCCH is transmitted or received, or a signal is transmitted or received through a PDCCH” includes “an EPDCCH is transmitted or received, or a signal is transmitted or received through an EPDCCH”.

That is, a physical downlink control channel used herein may indicate a PDCCH or an EPDCCH, and may indicate a meaning including both a PDCCH and an EPDCCH.

In addition, for ease of description, an EPDCCH, which corresponds to an embodiment of the present disclosure, may be applied to the part described using a PDCCH and to the part described using an EPDCCH.

Meanwhile, higher layer signaling includes an RRC signaling that transmits RRC information including an RRC parameter.

An eNB executes downlink transmission to terminals. The eNB may transmit a Physical Downlink Shared Channel (PDSCH) which is a primary physical channel for unicast transmission, and may transmit a Physical Downlink Control Channel (PDCCH) for transmitting downlink control information, such as scheduling required for reception of a PDSCH, and scheduling grant information for transmission of an uplink data channel (for example, a Physical Uplink Shared Channel (PUSCH)). Hereinafter, transmission and reception of a signal through each channel will be described as transmission and reception of a corresponding channel.

Latency Reduction

Discussion about latency reduction is underway. The main purpose of latency reduction is to standardize the operation of a short Transmission Time Interval (hereinafter referred to as “short TTI” or “sTTI”) in order to improve the throughput of TCP.

Studies on the effects feasible within the following range are in progress.
Assess specification impact, study feasibility, and performance of TTI lengths between 0.5 ms and one OFDM symbol, taking into account impact on reference signals and physical-layer control signaling
Backward compatibility shall be preserved so as to allow normal operation of pre-Rel 13 User Equipments (UEs) on the same carrier.

Latency reduction can be achieved by the following physical layer techniques.
short Transmission Time Interval (TTI)
reduced processing time in implementation
new frame structure of TDD

Additional discussion on latency reduction is in progress, as follow.
The following design assumptions are considered:
No shortened TTI spans over a subframe boundary.
At least for SIBs and paging, a PDCCH and a legacy PDSCH are used for scheduling.
The potential specific impacts for the followings are studied.
A UE is expected to receive an sPDSCH at least via downlink unicast
An sPDSCH refers to a PDSCH carrying data in an short TTI.
A UE is expected to receive a PDSCH via downlink unicast.
Whether a UE is expected to receive both an sPDSCH and a PDSCH via downlink unicast simultaneously.
Further study on the number of supported short TTIs
The following design assumptions are used for the study
From the perspective of an evolved NodeB (eNB), an existing non-sTTI and an sTTI can be frequency-division multiplexed (FDMed) in the same subframe and the same carrier.
Further study on other multiplexing method(s) with an existing non-sTTI for a UE supporting latency reduction features
In this study, the following aspects are assumed.
PSS/SSS, PBCH, PCFICH and PRACH, Random access, SIB and Paging procedures are not modified.
The following aspects are further studied.
However, the study is not limited to them.
Design of an sPUSCH DM-RS
Scheme 1: The same DM-RS symbol is shared by multiple short-TTIs within the same subframe.
Scheme 2: A DM-RS is contained in each sPUSCH.
HARQ for an sPUSCH
Whether/how to realize an asynchronous and/or synchronous HARQ
an sTTI operation in a Pcell and an SCell by CA, in addition to a non-CA case

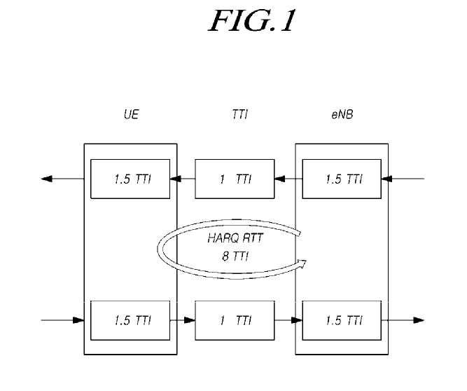

FIG. 1 is a diagram illustrating processing delays and a HARQ Round Trip Time (RTT) in an eNB and a UE.

Basically, an average downlink latency calculation operation may calculate latency according to the following procedure.

The LTE user-plane one-way latency for a scheduled UE consists of the fixed node-processing delays and 1 TTI duration for transmission, as shown in FIG. 1 provided below. Assuming that the processing times can be scaled by the same factor of TTI reduction keeping the same number of HARQ processes, one-way latency can be calculated as follows:

D=1.5 TTI (eNB processing and scheduling)+1 TTI (transmission)+1.5 TTI (UE processing)+n*8 TTI (HARQ retransmissions)

=(4+n*8)TTI.

Considering a typical case where there would be 0 or 1 retransmission, and assuming error probability of the first transmission to be p, the delay is given by:

D=(4+p*8)TTI.

So, for 0% BLER (Block Error Rate), D=4*TTI,

And for 10% BLER, D=4.8*TTI.

Average UE-Initiated UL Transmission Latency Calculation

It is assumed that a UE is in a connected/synchronized mode, and wants to perform UL transmission, such as sending a TCP ACK Table 1 shows the steps and their corresponding contribution to the UL transmission latency. To maintain the consistency in the comparison of a DL and a UL, an eNB processing delay is added after the UL data is received by the eNB (step 7).

TABLE 1

| Step | Description | Delay |
|---|---|---|
| 1. | Average delay to next SR opportunity | SR periodicity/2 |
| 2. | UE sends SR | 1 TTI |
| 3. | eNB decodes SR and generates scheduling | 3 TTI |
| | grant | |
| 4. | Transmission of scheduling grant | 1 TTI |
| | (assumed always error-free) | |
| 5. | UE processing delay (decoding Scheduling | 3 TTI |
| | grant + L1 encoding of data) | |
| 6. | UE sends UL transmission | (1 + p*8) TTI where |
| | | p is initial BLER. |
| 7. | eNB receives and decodes the UL data | 1.5 TTI |

In the table above, it is assumed that steps 1-4 and half of the delay of step 5 are due to a Scheduling Request, and the rest is associated with UL data transmission.

Resource Mapping of a Short TTI

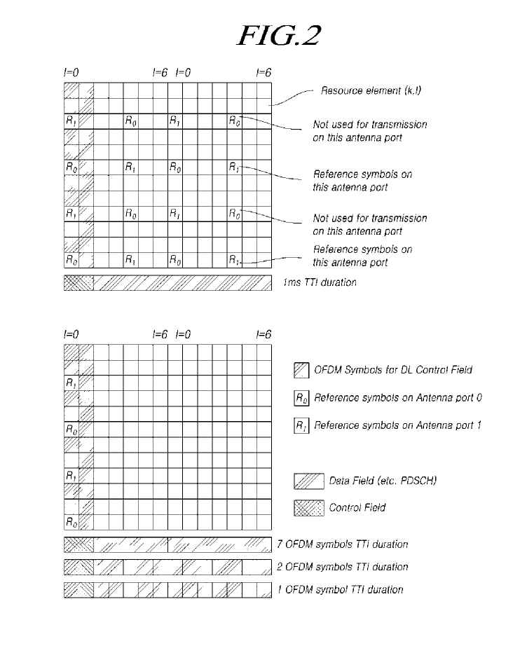

In FIG. 2, the resource map above shows the legacy resource mapping per PRB in one subframe, in consideration of two antenna ports and a 2-OFDM symbol control field. In FIG. 2, the resource map below is short TTI resource mapping, in consideration of a control field including two OFDM symbols in order to ensure backward compatibility. It is assumed that the loss rate of a PHY layer in a short TTI is (L_{legacy}, e.g. 5%-50%).

Calculation of the Transmission Block Size (TBS) of a Short TTI

According to the resource mapping and the TBS calculation formula given above, the loss rate of a PHY layer for a legacy PDSCH is calculated as follows:

$${L}_{legacy} = \frac{the number of reference symbols within PDSCH}{the number of REs within PDSCH} = \frac{22}{144} = 8.3 \%$$

For different short TTI durations, the TBS of a short TTI PDSCH is calculated as shown in Table 2 provided below.

TABLE 2

| TTI Duration | TBS of short TTI PDSCH (TBSₛₕₒᵣₜ) |
|---|---|
| 7 OFDM symbol | First time slot: ${TBS}_{short} = {TBS}_{legacy} \times \frac{60}{144} \times \frac{1 - {L}_{short}}{8.3 \%}$ |
| | Second time slot: ${TBS}_{short} = {TBS}_{legacy} \times \frac{84}{144} \times \frac{1 - {L}_{short}}{8.3 \%}$ |
| 2 OFDM symbol | ${TBS}_{short} = {TBS}_{legacy} \times \frac{24}{144} \times \frac{1 - {L}_{short}}{8.3 \%}$ |
| 1 OFDM symbol | ${TBS}_{short} = {TBS}_{legacy} \times \frac{12}{144} \times \frac{1 - {L}_{short}}{8.3 \%}$ |

Legacy PUCCH

A PUCCH is a UL control channel that a UE transmits to an eNB in response to the reception of a PDSCH. The UE may use various PUCCH formats in order to transmit Ack/Nack, CQI information, or the like with respect to a downlink data channel to an eNB.

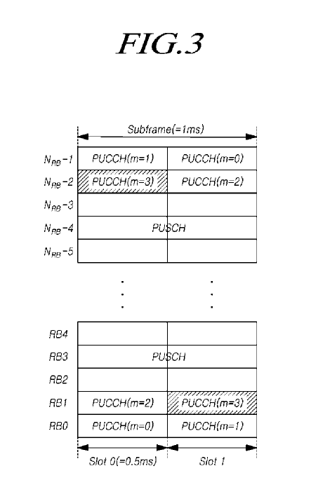

In the legacy LTE/LTE-Advanced frame structure (TTI=1 ms=14 OFDM symbols (Normal CP)/12 OFDM symbols (Extended CP)), slot-based PUCCH hopping of FIG. 3 may be allowed. The PUSCH hopping increases the frequency diversity of a PUCCH, thereby increasing the coverage of the PUCCH. Basically, this is because diversity gain exists when the same signal or a single information sequence is transmitted via different frequency bands.

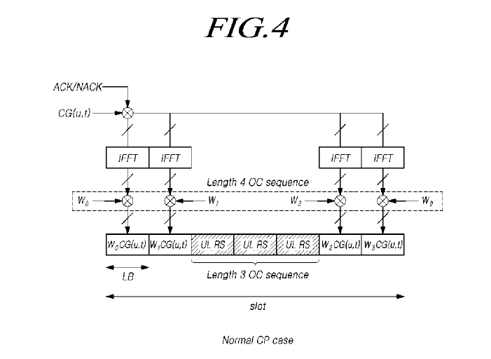

When the legacy PUCCH transmits Ack/NacK (A/N), resource allocation is applied using OCC (spreading)+CS (cyclic shift) based on format 1a and 1b. The legacy PUCCH is configured to include a 3-symbol RS and a 4-symbol A/N in a slot, as illustrated in FIG. 4.

The present disclosure considers A/N multiplexing resource allocation based on the CS of a Zadoff-Chu (ZC) sequence, excluding the existing OCC, by taking into consideration the fact that the number of symbols in an sPUCCH is small. In this instance, OCC spreading is not used, unlike the legacy structure.

Basically, the ZC sequence is defined as a cyclic shift value defined by RS r_{u,v}^{(α)}(n) provided below.

r_{u,v}^{(α)}(n)=e^{jαn}r̅_{u,v}(n),0≤n<M_{sc}^{RS} [Equation 1]

The present embodiment assumes the following basic structure for an SPUCCH A/N configuration excluding the OCC.

Here, PUCCH format 1a/b performs dynamic resource allocation. Basically, PUCCH format 1a/b performs dynamic allocation as shown in Equation 2 provided below, based on a CCE index of a scheduled PDCCH.

[symbol]

=n_{CCE}+N_{PUCCH}⁽¹⁾ [Equation 2]

Here, a PUCCH resource index n_{PUCCH}^{(1,\tilde{p})} for an Ack/Nack is determined based on n_{CCE} and N_{PUCCH}⁽¹⁾, wherein n_{CCE} is the lowest CCE index of a PDCCH used for Downlink Control Information (DCI) transmission for downlink resource allocation, and N_{PUCCH}⁽¹⁾ is transmitted in a higher layer. Here, N_{PUCCH}⁽¹⁾ is a kind of shift value set to separate PUCCH format 1a/1b from PUCCH format 2/3/4.

Additional agreements recently made in association with an sTTI are as follows:
Specify support for a transmission duration which is based on a 2-symbol sTTI and a 1-slot sTTI, for an sPDSCH/sPDCCH
Specify support for a transmission duration which is based on a 2-symbol sTTI, a 4-symbol sTTI, and a 1-slot sTTI, for an sPUCCH/sPUSCH
Down-selection is not precluded.
Study any impact on channel state information feedback and processing time, and if needed, specify necessary modifications
For FS1,2&3, a minimum timing n+3 is supported for UL grant to UL data and for DL data to DL HARQ for UEs capable of operating with reduced processing time with only the following conditions
A maximum TA is reduced to x ms, wherein x is less than or equal to 0.33 ms (where x<=0.33 ms, and an accurate value can be derived from detailed studies).
At least when scheduling by a PDCCH
For FS2, new DL HARQ and UL scheduling timing relations will be defined.
Details for further study (FFS)
FFS
A possible minimum timing of an n+2 TTI
FFS about a max TA in this case
FFS about other restrictions (if any) on when a reduced processing time of an n+2 TTI could be applied
Possibility of scheduling by an EPDCCH
A reduced processing time(s) may be configured for a UE via RRC
A dynamic fallback mechanism for a legacy processing timing (n+4) may be supported.
For an sPDSCH based on a CRS-based transmission scheme, the maximum number of supported layers is 4.
For sPDSCH based on a CRS based transmission scheme the maximum number of supported layers is 4.
The maximum number of supported layers is 2.
The maximum number of supported layers is 4.
The maximum number of supported layers is 8.
FFS for sPDSCH based on a DM-RS based transmission scheme it is recommended to increased PRB bundling size compared to PDSCH for at least sTTI lengths shorter than 1-slot

The embodiments described below may be applied to UEs, eNBs, and core network entities (e.g., MME) that use all mobile communication technologies. For example, the embodiments may be applied to a mobile communication UE to which LTE is applied, and the embodiments may also be applied to a next-generation mobile communication (5G mobile communication, New-RAT) UE, eNB, and core network entity (Access and Mobility Function (AMF)). Hereinafter, for ease of description, an base station may indicate an eNB in LTE/E-UTRAN, or may indicate a gNB, which is an base station (a Central Unit (CU), a Distributed Unit (DU), or an entity in which a CU and a DU are implemented as a single logical entity) in a 5G wireless network where the CU and the DU are separated.

Also, in the embodiment, a normal transmission time interval or an existing/legacy time interval indicates a subframe time interval of 1 ms, which is used in the legacy LTE/LTE-Advanced. That is, in the case of the legacy LTE/LTE-Advanced, one subframe time interval is 1 ms and may include 14 symbols (in the case of a normal CP) or 12 symbols (in the case of an extended CP). Thus, the time interval may be 14 symbols or 12 symbols. Therefore, when the expression “existing/legacy or normal” in the embodiments provided below may indicate the legacy LTE/LTE-Advanced system where a subframe is 1 ms.

Also, a short transmission time interval type in the embodiments is to distinguish the symbol length of a TTI m a short transmission time interval. Specifically, the symbol length indicates the number of symbols included in a single short transmission time interval. In the embodiment, a short transmission time interval may be configured to include two, three, or seven symbols.

Also, in the embodiment, a symbol indicates an OFDM symbol, and the symbol may be an RS symbol or a data symbol. A data symbol indicates an OFDM symbol that stores information

Also, in the embodiment, a downlink channel may be a downlink control channel or a downlink data channel. In a short transmission time interval (hereinafter referred to as a short TTI or an sTTI) frame structure, a downlink channel may be a shortened downlink control channel (sPDCCH) or a shortened downlink data channel (sPDSCH).

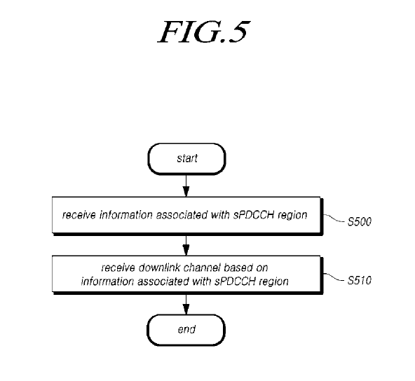

FIG. 5 is a flowchart illustrating a procedure of receiving a downlink channel in a short Transmission Time Interval (sTTI) frame structure by a UE according to at least one of embodiments.

Referring to FIG. 5, a UE may receive information associated with a shortened downlink control channel (shortened PDCCH (sPDCCH)) region from an eNB in operation S500.

The sPDCCH region indicates a region in which an SPDCCH may be transmitted in an sTTI. The sPDCCH region is configured in units of symbols for the time domain. The sPDCCH region is configured in units of Resource Blocks (RBs) for the frequency domain. In the embodiment, the sPDCCH region may have a single symbol-based configuration or a multi-symbol-based configuration. For example, the sPDCCH region may include one or two symbols.

The UE may receive information associated with the sPDCCH region from the eNB via RRC signaling.

Also, the UE may receive a downlink channel from the eNB based on the information associated with the sPDCCH region received from the eNB in operation S510.

The sPDCCH region indicates a region where an SPDCCH may be transmitted, but all resources included in the sPDCCH region may not need to be used for an sPDCCH. In this instance, a resource that is not used for an SPDCCH from among the resources belonging to the sPDCCH region does not remain in an unused state. Such a resource may be reused for transmitting an sPDSCH. That is, an sPDCCH and an sPDSCH may be multiplexed within the sPDCCH region.

As described above, in the case in which an sPDCCH and an sPDSCH are multiplexed in the sPDCCH region, when a UE receives a downlink channel from an eNB, the UE needs information indicating a resource corresponding to an sPDCCH and a resource corresponding to an sPDSCH from among the resources in the sPDCCH region. That is, the UE needs to receive information indicating a resource that is not used for the sPDCCH from among the resources in the sPDCCH region. The information may be expressed as a number of bits. The UE may receive the information indicating a resource that is not used for an sPDCCH, from among the resources belonging to the sPDCCH region, from the eNB via DCI.

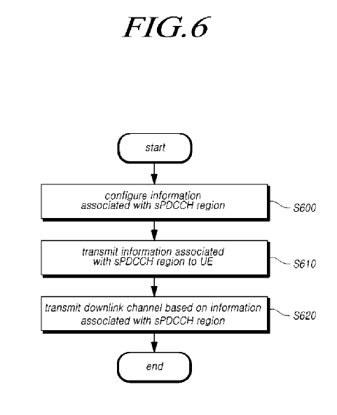

FIG. 6 is a flowchart illustrating a procedure of transmitting a downlink channel in a frame structure having an sTTI by an eNB according to at least one of embodiments.

Referring to FIG. 6, an eNB may configure information associated with an sPDCCH region in operation S600.

As described in FIG. 5, an sPDCCH region indicates a region where an sPDCCH may be transmitted in an sill. The sPDCCH region may be configured in units of symbols for the time domain. The sPDCCH region may be configured in units of Resource Blocks (RBs) for the frequency domain. In the present embodiment, the sPDCCH region may have a single symbol-based configuration or a multi-symbol-based configuration. For example, the sPDCCH region may be configured to include one or two symbols.

The eNB may transmit information associated with the configured sPDCCH region to a UE in operation S610. For example, the eNB may transmit information associated with the sPDCCH region to the UE via RRC signaling.

The eNB may transmit a downlink channel to the UE based on the information associated with the configured sPDCCH region in operation S620.

As described in FIG. 5, not all the resources in the sPDCCH region may need to be used for an sPDCCH. Thus, a resource that is not used for the sPDCCH from among the resources in the sPDCCH region does not remain in an unused state, and such a resource may be reused for transmitting an sPDSCH. That is, an sPDCCH and an sPDSCH may be multiplexed within the sPDCCH region.

As described above, in the case in which an sPDCCH and an sPDSCH are multiplexed in the sPDCCH region, information that indicates, to the UE, a resource corresponding to an sPDCCH and a resource corresponding to an sPDSCH from among resources in the sPDCCH region may be needed. That is, the eNB needs to transmit information indicating a resource that is not used for an sPDCCH from among resources in the sPDCCH region. In this instance, as described above, the eNB may transmit information indicating a resource that is not used for the sPDCCH from among the resources belonging to the sPDCCH region to the UE via DCI.

Hereinafter, various embodiments associated with a method of transmitting and receiving a downlink channel in a short transmission time interval frame structure, by a UE and an eNB, will be described in detail. Embodiments described hereinafter may be used separately or by a combination thereof.

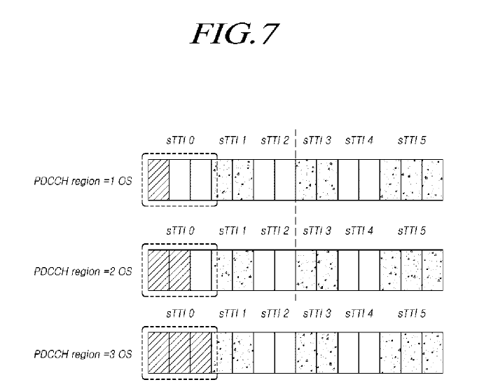

First, in the case of a 2-symbol sTTI and a 7-symbol sTTI, sTTI structures in DL and UL may be similar to each other. Currently, a 2-symbol sTTI structure and a 7-symbol sTTI structure have been determined, and each structure intends to maintain a slot boundary of each subframe. For example, the 2-symbol sTTI structure may include an uplink/downlink sTTI as shown in FIG. 7.

Referring to FIG. 7, in the 2-symbol sTTI structure, each sTTI basically includes two symbols. However, if all sTTIs are configured to include two symbols, one symbol is left over when seven symbols (7 being an odd number) is divided by two, and the slot boundary of the subframe including seven symbols may not be maintained. Therefore, in order to maintain the slot boundary of each subframe, sTTI0 (e.g., sTTI5), which is one of the sTTIs included in a slot, may be configured to include three symbols. That is, in the 2-symbol sTTI structure, each sTTI may include two or three symbols.

However, in the 7-symbol sTTI structure, each sTTI includes seven symbols, and has the same length as that of a slot of a legacy subframe.

In the present embodiment, a method of multiplexing an sPDCCH and an sPDSCH will be described in detail based on what has been described above.

### Example 1. Configure an x-Symbol-Based sPDCCH Region and Transmit an sTTI Control Channel

In the present embodiment, it is basically assumed that that an sPDCCH region of an sTTI is semi-statically configured via RRC signaling. Therefore, an sPDCCH region may separately exist in a configured sTTI region.

When the sPDCCH region is configured via RRC, the following items need to be considered. However, a part or the entirety of sPDCCH region configuration information which is proposed as below may be transmitted via dynamic signaling by DL grant. Particularly, when 2-level DCI is applied, sPDCCH region configuration information may be transmitted to each UE via DCI2 (control information transmitted via a legacy PDCCH).
set the number of symbols (x) of an sPDCCH region
In the embodiment, a single-symbol-based sPDCCH configuration and a multi-symbol-based sPDCCH configuration may be allowed.

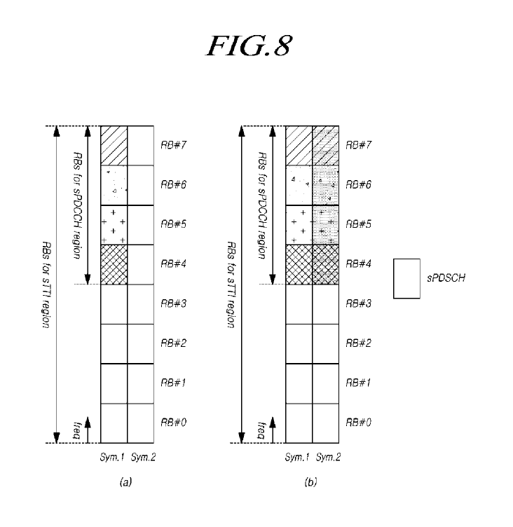

Referring to FIG. 8, in the case of a 2-symbol sTTI, an sPDCCH region may be configured to include one symbol as shown in FIG. 8A, or the sPDCCH region may be configured to include two symbols as shown in FIG. 8B. The remaining region that is not configured as the sPDCCH region may be used for an sPDSCH.

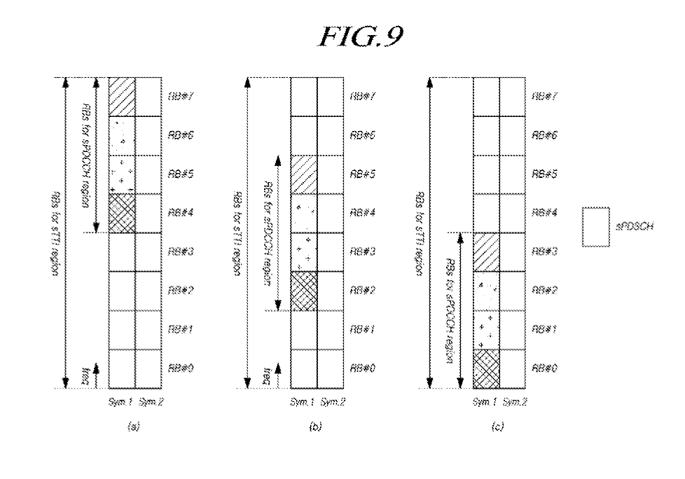

As another example, in the case of a 7-symbol sTTI, the sPDCCH region may be configured to include a maximum of 7 symbols.
set the location of an sPDCCH region in the frequency domain
   It is basically assumed that sPDCCH region configuration information is configured in the form of FDM/TDM. Also, the following configuration may be basically supported in the sPDCCH region.
   sPDCCH region allocation may be basically configured in consecutive regions in the frequency domain. In this instance, the location of the sPDCCH region may be set as shown in FIG. 9A, 9B, or 9C.

Referring to FIGS. 9A, 9B, and 9C, consecutive RBs from RB#4 to RB#7 may be configured as the sPDCCH region, as shown in FIG. 9A. Consecutive RBs from RB#2 to RB#5 may be configured as the sPDCCH region shown in FIG. 9B. Consecutive RBs from RB#0 to RB#3 may be configured as the sPDCCH region shown in FIG. 9C.

Conversely, sPDCCH region allocation in a dispersed manner may also be possible. That is, the sPDCCH region allocation may be performed in a manner in which RBs included in the sPDCCH region may be inconsecutive. In this instance, an sPDCCH region allocation pattern may need to be transmitted to a UE such that the UE is capable of recognizing RBs allocated to the sPDCCH region.

### Embodiment 1-1. In the Case of a 2-Symbol sTTI, Allocate a Single Symbol/Resource Block (RB)-Based sCCE or Provide sCCE Aggregation

In the present embodiment, a method of allocating an sPDCCH region in a 2-symbol sTTI will be described in detail.

For example, when it is assumed that an sTTI region is configured in a total of 10 PRBs, only four PRBs are allocated for an sPDCCH region, the remaining six PRBs may be allocated for an sPDSCH, and multiplexing is performed. According to the embodiment, in the case of an sPDCCH, a Control Channel Element (CCE) is configured based on an RB unit, and thus a total of four sCCEs may exist. Therefore, the sPDCCH may support up to sCCE aggregation level 4.

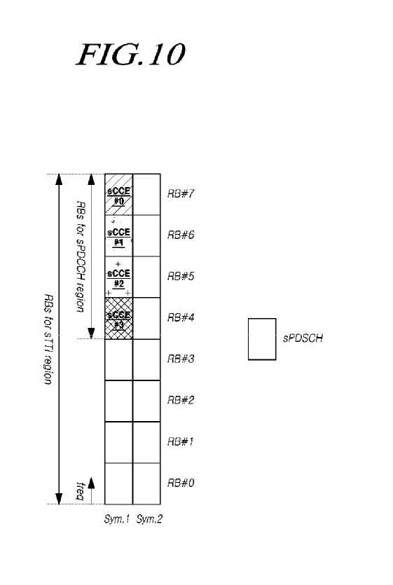

Referring to FIG. 10, in an sPDCCH region, a total of four sCCEs (e.g., sCCE#0, sCCE#1, sCCE#2, and sCCE#3) may be allocated to four RBs from RB#4 to RB#7, using only a single symbol (Sym.1). The remaining region may be used for transmitting an sPDSCH.

### Embodiment 1-2. In the Case of a 2-Symbol sTTI, Allocate a 2-Symbol/Resource Block (RB)-Based sCCE or Provide sCCE Aggregation

In the present embodiment, from the perspective of the method of allocating an sPDCCH region in the 2-symbol sTTI, a method of utilizing both of the two symbols allocated to the sPDCCH region will be described in detail.

For example, when it is assumed that an sTTI region is configured in a total of 10 PRBs, like Embodiment 1-1, only four PRBs are allocated for an sPDCCH region, the remaining six PRBs may be allocated for an sPDSCH, and multiplexing is performed. According to the present embodiment, in the case of an sPDCCH, a Control Channel Element (CCE) is configured based on an RB unit. Thus, four sCCEs may be configured for each symbol. Accordingly, a total of eight sCCEs (4*2=8) may be configured.

As another configuration method, an sCCE may be configured based on two symbols and one RB. In this instance, the total number of sCCE may decrease to half, that is, four, and the size of one sCCE increases two-fold and the number of REs per sCCE may increase two-fold.

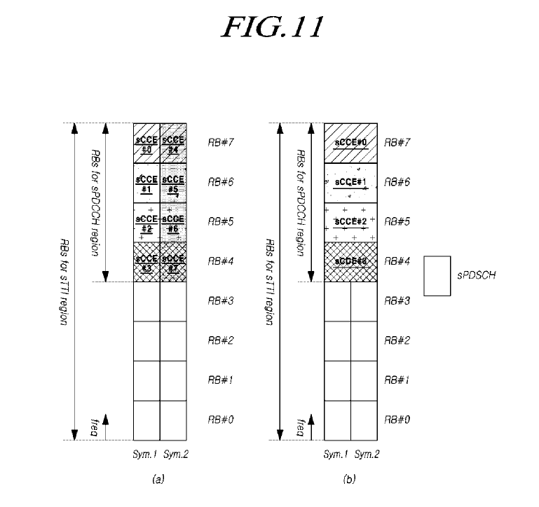

Referring to FIG. 11A, an sPDCCH region includes four RBs and two symbols. A CCE is configured based on each RB of the sPDCCH region, and thus a total of 8 sCCEs, from sCCE#0 to sCCE#7, may exist.

Referring to FIG. 11B, an sCCE is configured based on two symbols, and thus a total of four sCCEs from sCCE#0 to sCCE#3 exist. The size of each sCCE is two times that shown in FIG. 11A.

### Embodiment 1-3. An sCCE has Subcarriers, the Number of which is Equal to the Number of Subcarriers of a Single-Symbol-RB, Irrespective of Density and the Configuration of a DMRS

In the present embodiment, a basic unit used for configuring an sCCE will be described. Basically, a legacy RB has 12 subcarriers per symbol. In the present embodiment, a system that has 12 subcarriers per symbol is used as it is.

For example, although two or three subcarriers from among 12 subcarriers are allocated for a DMRS, the number of subcarriers per symbol is 12 and is not changed. In this instance, the corresponding symbol may be excluded from a detection process. Accordingly, instead of 12 REs, the sCCE may be configured to include ten or nine REs, obtained by subtracting the number of DMRS REs (assuming 2 or 3 REs are used) from 12.

### Example 2. In the Case of a 7-Symbol (or a Slot-Based) sTTI, Selectively Apply sPDCCH Configuration Information

In the present embodiment, a method of defining an sPDCCH in a 7-symbol sTTI will be described in detail. In the case of the 7-symbol sTTI, a single TTI includes seven symbols, which is basically the same as one slot of a legacy subframe.

Therefore, in the case of the 7-symbol sTTI, an sPDCCH region may be configured according to two schemes, which will be described below. Those are a method of allocating an sPDCCH region to three or fewer OFDM symbols in the entire frequency band in a dispersed manner, like the legacy PDCCH allocation, and a method of allocating an sPDCCH region to a predetermined resource region.

According to the present embodiment, in the case of the 7-symbol sTTI, one of the above-described two methods may be selectively applied when the sPDCCH region is configured. The corresponding information may be transmitted to a UE via RRC signaling.

The method of allocating an sPDCCH to a predetermined resource may be implemented according to Embodiment 1, Embodiment 1-1, Embodiment 1-2, and Embodiment 1-3. The case that uses the legacy PDCCH configuration as it is may be implemented according to Embodiment 2-1 provided below.

### Embodiment 2-1. Signaling Corresponding Information Indicating the Number of Symbols to a UE when a Legacy PDCCH Allocation Method is Reused in a 7-Symbol sTTI

Basically, in the case of the legacy PDCCH, the number of symbols allocated to a PDCCH may be recognized by detecting a PCFICH. When the structure is equally applied to an sTTI located in a second slot, a UE needs to detect a PCFICH again, which is a drawback. Therefore, to overcome the drawback, the present embodiment provides the method described below.
Method 1: A UE preferentially detects a short PCFICH, which is the same as a legacy PCFICH, in order to detect an sPDCCH region transmitted in a second slot. This is a method of introducing a new short PCFICH, and the fundamental principal of the short PCFICH is to equally reuse the legacy PCFICH.
Method 2: In order to detect an sPDCCH region transmitted in a second slot, an sPDCCH is detected using the number of symbols, which is defined in advance. In this instance, the number of symbols in the corresponding sPDCCH may be transmitted to a UE via RRC signaling.
Method 3: An sPDCCH region transmitted in a second slot is transmitted based only on a single symbol, and a UE may perform single-symbol-based sPDCCH detection. In this instance, the sPDCCH region is fixed in advance to a single symbol region, and thus there is no need to perform signaling to the UE.

### Example 3. Use a Resource, which is not Used for sPDCCH Detection by a UE, for Data Transmission

In the present embodiment, an operation may be provided for transmitting an sPDSCH, that is, data, in a resource where an sPDCCH is not detected from among an sPDCCH region configured for sPDCCH detection by a UE. In this instance, sTTI regions may be configured to be orthogonal to each other or different from each other between different UEs.

When an sPDSCH is transmitted in a resource where an sPDCCH is not detected from among the sPDCCH region, the resources of the sPDCCH may be efficiently utilized

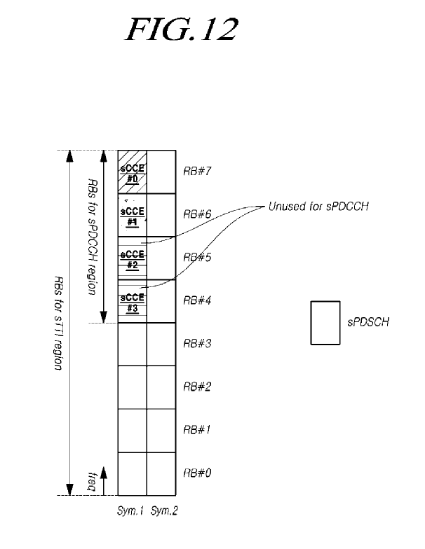

For example, referring to FIG. 12, an sPDCCH of a UE is not detected from a region corresponding to sCCE#2 and sCCE#3 in the sPDCCH region. That is, although the resource is allocated as the sPDCCH region, the resource is not used for an sPDCCH, and remains empty.

Therefore, an eNB allocates the corresponding band to an sPDSCH to transmit normal data to the UE. That is, the eNB allocates an sPDSCH to the unused sPDCCH region and transmits the same. In this instance, the UE may preferentially detect control information about itself from the sPDCCH region. The UE identifies the detected sPDCCH, assumes the remaining region, where the sPDCCH is not detected, to be an sPDSCH, and performs data detection.

In the present embodiment, a detailed method may be provided in association with a method of configuring an sPDCCH region and a method of multiplexing an sPDCCH and an sPDSCH in the 3GPP LTE/LTE-A system. The principal of the method may be applied as it is to similar signals and channels, and application thereof may not be limited to the new frame structure.

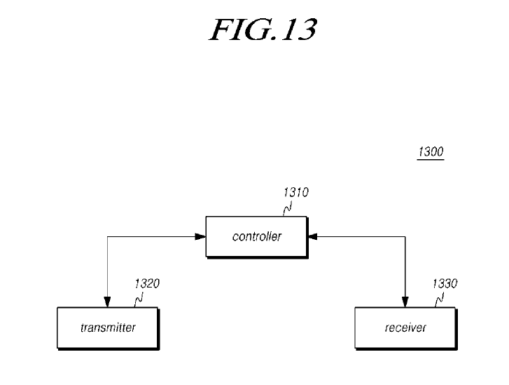

FIG. 13 is a diagram illustrating a configuration of an eNB according to at least one of embodiments.

Referring to FIG. 13, an eNB 1300 includes a controller 1310, a transmitter 1320, and a receiver 1330.

The controller 1310 may control the operation of the eNB 1300 in association with transmitting a downlink channel in a short transmission time interval frame structure, which is required to implement at least one of the above-described embodiments. Specifically, the controller 1310 may configure information associated with an sPDCCH region.

In this instance, the sPDCCH region may include a single symbol or multiple symbols in the time domain, as described above. For example, the sPDCCH region may be configured to include one or two symbols.

The transmitter 1320 and the receiver 1330 are used for transmitting/receiving, to/from a UE, a signal, a message, and data needed for implementing the aforementioned present disclosure.

Specifically, the transmitter 1320 may transmit, to the UE, information associated with the sPDCCH region configured by the controller 1310. The transmitter 1320 may transmit a downlink channel to the UE based on the information associated with the sPDCCH region.

When the transmitter 1320 transmits the information associated with the sPDCCH region to the UE, the information associated with the sPDCCH region may be transmitted to the UE via RRC signaling.

When the transmitter 1320 transmits a downlink channel, that is, a downlink control channel or a downlink data channel, to the UE based on the information associated with the sPDCCH region, a resource that is not used for an sPDCCH from among resources belonging to the sPDCCH region may be reused for an sPDSCH. In this instance, information indicating the resource that is not used for the sPDCCH may be transmitted to the UE via DCI.

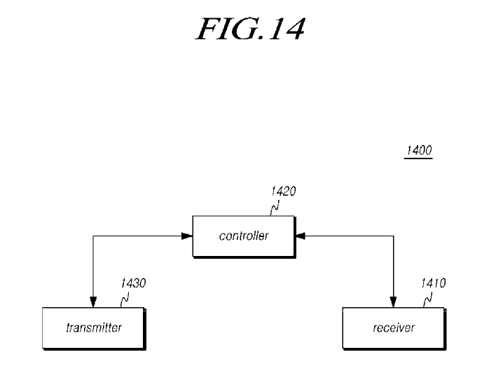

FIG. 14 is a diagram illustrating a configuration of a UE according to at least one of embodiments.

Referring to FIG. 14, a UE 1400 may include a receiver 1410, a controller 1420, and a transmitter 1430.

The receiver 1410 may receive downlink control information, data, and a message from an eNB via a corresponding channel.

Specifically, the receiver 1410 may receive information associated with an sPDCCH region from the eNB, and the receiver 1410 may receive a downlink channel from the eNB based on the received information associated with the sPDCCH region.

In this instance, the sPDCCH region may include a single symbol or multiple symbols in the time domain, as described above. For example, the sPDCCH region may be configured to include one or two symbols.

In this instance, the UE 1400 may receive information associated with an sPDCCH region from the eNB via RRC signaling.

Also, the controller 1420 may control the operation of the UE 1200 in association with receiving a downlink channel in a short transmission time interval frame structure, which is required in order to implement at least one of the above-described embodiments.

Specifically, the controller 1420 may detect downlink control information or downlink data from the downlink channel received from the eNB.

When a downlink channel, that is, a downlink control channel or a downlink data channel, is transmitted to the UE based on the information associated with the sPDCCH region, a resource that is not used for an sPDCCH from among resources belonging to the sPDCCH region may be reused for an sPDSCH. In this instance, information indicating the resource that is not used for the sPDCCH may be received from the eNB via DCI.

The standard details or standard documents mentioned in the above embodiments are omitted for the simplicity of the description of the specification, and constitute a part of the present specification. Therefore, when a part of the contents of the standard details and the standard documents is added to the present specifications or is disclosed in the claims, it should be construed as falling within the scope of the present disclosure.

Although a preferred embodiment of the present disclosure has been described for illustrative purposes, those skilled in the art will appreciate that various modifications, additions and substitutions are possible, without departing from the scope and spirit of the disclosure as disclosed in the accompanying claims. Therefore, exemplary aspects of the present disclosure have not been described for limiting purposes. The scope of the present disclosure shall be construed on the basis of the accompanying claims in such a manner that all of the technical ideas included within the scope equivalent to the claims belong to the present disclosure.

Moreover, the terms “system,” “processor,” “controller,” “component,” “module,” “interface,”, “model,” “unit” or the like are generally intended to refer to a computer-related entity, either hardware, a combination of hardware and software, software, or software in execution. For example, a component may be, but is not limited to being, a process running on a processor, a processor, a controller, a control processor, an object, an executable, a thread of execution, a program, and/or a computer. By way of illustration, both an application running on a controller or processor and the controller or processor can be a component. One or more components may reside within a process and/or thread of execution and a component may be localized on one computer and/or distributed between two or more computers.

What is claimed is:

1. A method of receiving a downlink channel in a short Transmission Time Interval (sTTI) frame structure by a User Equipment (UE), the method comprising:
receiving information associated with a shortened downlink control channel (shortened PDCCH (sPDCCH)) region from an evolved NodeB (eNB); and
receiving a downlink channel from the eNB based on the information associated with the sPDCCH region,
wherein the sTTI is configured to include at least one of two symbols, three symbols, and seven symbols.

2. The method of claim 1, wherein the sPDCCH region is configured to include at least one of one symbol and two symbols.

3. The method of claim 1, wherein the information associated with the sPDCCH region is received from the eNB via RRC signaling.

4. The method of claim 1, wherein a resource that is not used for an sPDCCH from among resources belonging to the sPDCCH region is reused for a shortened downlink data channel (shortened PDSCH (sPDSCH)).

5. The method of claim 4, wherein information indicating the resource that is not used for the sPDCCH is received from the eNB via Downlink Control Information (DCI).

6. A method of transmitting a downlink channel in a short Transmission Time Interval (sTTI) frame structure by an evolved NodeB (eNB), the method comprising:
configuring information associated with a shortened downlink control channel (shortened PDCCH (sPDCCH)) region;
transmitting the information associated with the sPDCCH region to a User Equipment (UE); and
transmitting a downlink channel to the UE based on the information associated with the sPDCCH region,
wherein the sTTI is configured to include at least one of two symbols, three symbols, or seven symbols.

7. The method of claim 6, wherein the sPDCCH region is configured to include at least one of one symbol and two symbols.

8. The method of claim 6, wherein the information associated with the sPDCCH region is transmitted to the UE via RRC signaling.

9. The method of claim 6, wherein a resource that is not used for an sPDCCH from among resources belonging to the sPDCCH region is reused for a shortened downlink data channel (shortened PDSCH (sPDSCH)).

10. The method of claim 9, wherein information indicating the resource that is not used for the sPDCCH is transmitted to the UE via Downlink Control Information (DCI).

11. A User Equipment (UE) for receiving a downlink channel in a short Transmission Time Interval (sTTI) frame structure, the UE comprising:
a receiver configured to receive information associated with a shortened downlink control channel (shortened PDCCH (sPDCCH)) region from an evolved NodeB (eNB) and to receive a downlink channel from the eNB based on the information associated with the sPDCCH region; and
a controller configured to detect at least one of downlink control information and downlink data from the downlink channel,
wherein the sTTI is configured to include at least one of two symbols, three symbols, and seven symbols.

12. The UE of claim 11, wherein the sPDCCH region is configured to include at least one of one symbol and two symbols.

13. The UE of claim 11, wherein the information associated with the sPDCCH region is received from the eNB via RRC signaling.

14. The UE of claim 11, wherein a resource that is not used for an sPDCCH from among resources belonging to the sPDCCH region is reused for a shortened downlink data channel (shortened PDSCH (sPDSCH)).

15. The UE of claim 14, wherein the information indicating the resource that is not used for the sPDCCH is received from the eNB via Downlink Control Information (DCI).
